(19) United States
(12) Patent Application Publication
(10) Pub. No.: US 2011/0305363 A1
(43) Pub. Date: Dec. 15, 2011

(54) Electronic apparatus and speaker thereof

(75) Inventor: Ming-Shiang Ke, Taipei Hsien (TW)

(73) Assignee: Wistron Corporation, Taipei Hsien (TW)

(21) Appl. No.: 12/801,553

(22) Filed: Jun. 15, 2010

(51) Int. Cl. H04R 1/02

(52) U.S. Cl. 381/395

(57) ABSTRACT

A speaker case is disclosed. The speaker case comprises a main member and a sound guiding member. The sound guiding member is connected to the main member via at least one connecting part to form an integrated structure. The at least one connecting part is capable of being a fulcrum for turning the main member or the sound guiding member, and for combining with the main member and the sound guiding member together.

### BACKGROUND OF THE INVENTION

1. Field of the Invention

The present invention relates to a speaker case and, more particularly, to a speaker case which can be made and assembled easily.

2. Description of the Related Art

Generally, an electronic apparatus with sound playing function can output sound via speakers which are disposed in the electronic apparatus or connected externally to the electronic apparatus. For a built-in speaker of the electronic apparatus, the physical volume of the speaker is usually smaller due to inner space limitations of the electronic apparatus, and its playing effect may be limited. Some manufacturers design a sound guiding structure corresponding to the built-in speaker to focus the sound outputted by the speaker. The outputted sound can be transmitted through the sound guiding structure to improve the playing effect.

Please refer to FIG. 1. FIG. 1 is an explosive view showing a speaker module 200 of the prior art. In the prior art, as shown as FIG. 1, a speaker module 200 comprises a speaker 210, a case 220, and a sound guiding member 230. The speaker 210 can be disposed in the case 220, and the case 220 combines with the sound guiding member 230 via screws to form the speaker module 200. To avoid gaps between the case 220 and the sound guiding member 230, buffer elements 240, e.g. foam material or nonwoven material, are disposed between the case 220 and the sound guiding member 230 to reduce the dispersion of the sound and vibration due to sound waves.

However, it may take a lot of time for the manufacturer to assemble the speaker 200 module via screws, and the disposal of the buffer materials may entail additional costs and increased difficulty of assembling the speaker module 200.

### SUMMARY OF THE INVENTION

It is an object of the present invention to provide a speaker case which can be made and assembled easily.

In order to achieve the above object, the present invention discloses a speaker case comprises a main member and a sound guiding member, the main member comprises at least one fixing portion and a sealing portion; the sound guiding member comprises at least one connecting portion, at least one corresponding fixing portion and a corresponding sealing portion, and the sound guiding member is connected to the main member via the at least one connecting portion; wherein each corresponding fixing portions corresponds to each fixing portions, and the corresponding sealing portion corresponds to the sealing portion. The at least one connecting portion is capable of being a fulcrum for turning the main member or the sound guiding member, and the main member can be combined with the sound guiding member by fastening each fixing portion and each corresponding fixing portion together. Therefore, the speaker case of the present invention can be assembled without any tools and provide better effects for sound focusing.

The present invention discloses an electronic apparatus comprises a main body and at least one speaker module. Each speaker module comprises the above-mentioned speaker case and a speaker disposed in the speaker case. The electronic apparatus of the present invention can provide an audio playing function via each speaker module.

### BRIEF DESCRIPTION OF THE DRAWINGS

FIG. 1 is an explosive view showing a speaker module of the prior art;

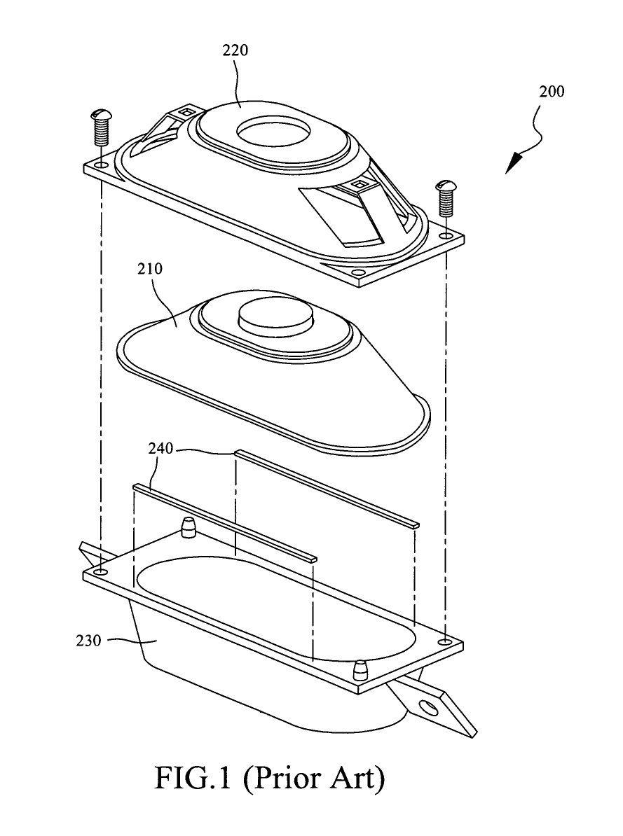

FIG. 2 is a structural front view showing a speaker case of the present invention;

FIG. 3 is a structural rear view showing a speaker case of the present invention;

FIG. 4 is a schematic view showing a combined speaker case of the present invention;

FIG. 5 is a sectional schematic view showing the combined speaker case along a sectional line A-A′ in FIG. 4 of the present invention; and

FIG. 6 is an illustrative view showing an electronic apparatus disposed at least one speaker module of the present invention.

### DETAILED DESCRIPTION OF THE PREFERRED EMBODIMENT

The advantages and innovative features of the invention will become more apparent from the following detailed description when taken in conjunction with the accompanying drawings.

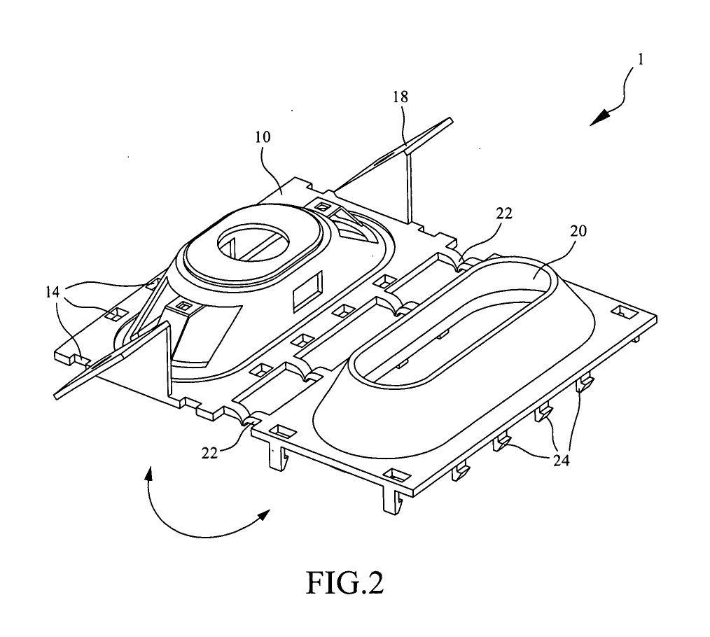

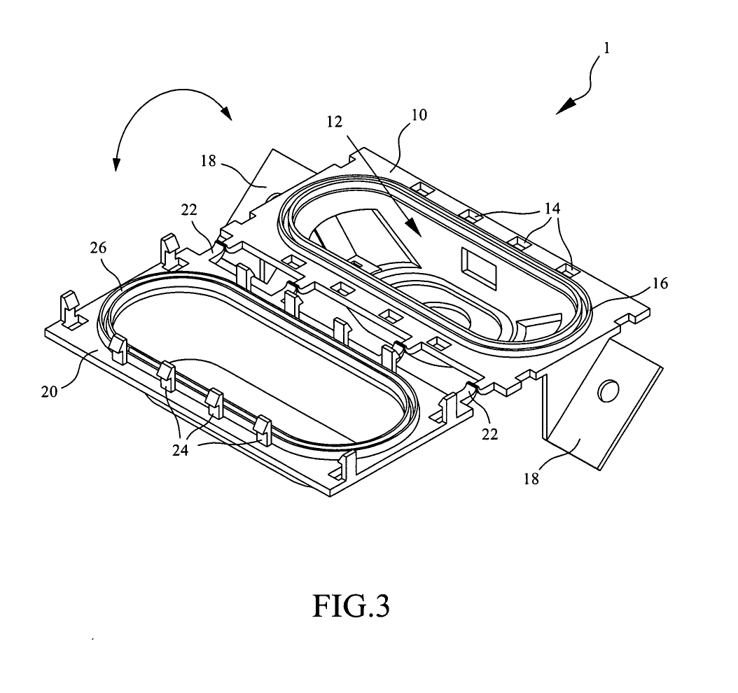

Please refer to FIG. 2 and FIG. 3. FIG. 2 is a structural front view showing a speaker case 1 of the present invention. FIG. 3 is a structural rear view showing a speaker case 1 of the present invention. As shown in FIG. 2 and FIG. 3, the speaker case 1 is applied in an electronic apparatus (not shown). The speaker case 1 comprises a main member 10 and a sound guiding member 20. The main member 10 and sound guiding member 20 are made of a plastic material, and they can be combined to form an integrated structure to reduce costs and manufacturing time.

The main member 10 comprises a space 12 for disposing a speaker (not shown), at least one fixing portion 14, and a sealing portion 16. The sound guiding member 20 comprises at least one connecting portion 22, at least one corresponding fixing portion 24, and a corresponding sealing portion 26. The sound guiding member 20 is connected to the main member 10 via the at least one connecting portion 22, and each connecting portion 22 is flexible. The at least one connecting portion 22 is capable of being a fulcrum for turning the main member 10 or the sound guiding member 20, and combining the main member 10 and the sound guiding member 20 together. Each corresponding fixing portion 24 of the sound guiding member 20 corresponds to a fixing portion 14 of the main member 10, so as to allow combination of the main member 10 and the sound guiding member 20 by fastening each fixing portion 14 and each corresponding fixing portion 24 together. In this embodiment, each fixing portion 14 is an aperture, and each corresponding fixing portion 24 is a hook capable of hooking the main member 10 through the aperture. The structures of the fixing portion 14 and the corresponding fixing portion 24 can be replaced or other structures with a fixing function used; the present invention is not limited thereto.

The corresponding sealing portion 26 of the sound guiding member 20 corresponds to the sealing portion 16 of the main member 10, and a sealing effect can be provided via the sealing portion 16 and the corresponding sealing portion 26 when the main member 10 is combined with the sound guiding member 20. In this embodiment, the sealing portion 16 is an annular groove structure, and the corresponding sealing portion 26 is an annular protrusion structure. The annular protrusion structure is capable of engaging correspondingly with the annular groove structure to form a sealing status between the main member 10 and the sound guiding member 20. The structures of the sealing portion 16 and the corresponding sealing portion 26 can be replaced or other structures with a sealing function used; the present invention is not limited thereto.

The main member 10 further comprises at least one fixing structure 18. The speaker case 1 of the present invention can be combined with an electronic apparatus (not shown) via the at least one fixing structure 18 by screws or the like. For different structure designs of the speaker case 1, the at least one fixing structure 18 can also be disposed on the sound guiding member 20.

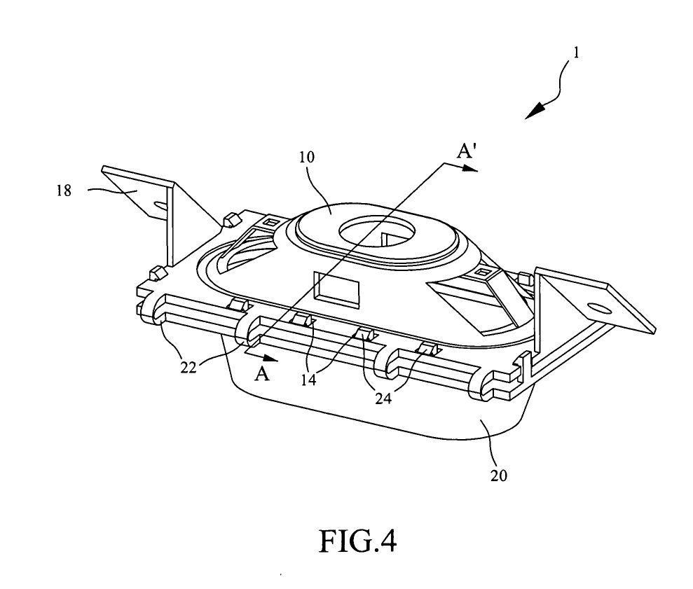

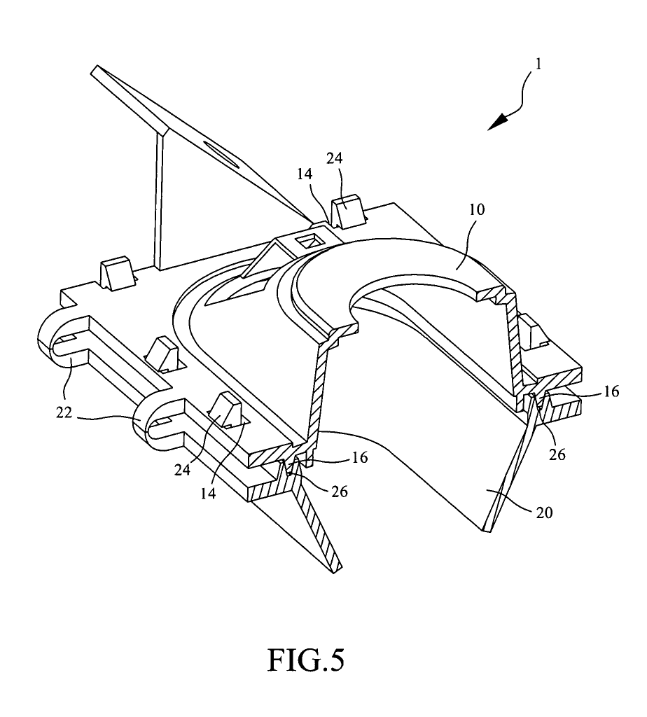

Please refer to FIG. 4 and FIG. 5. FIG. 4 is a schematic view showing a combined speaker case 1 of the present invention. FIG. 5 is a sectional schematic view showing the combined speaker case 1 along a sectional line A-A′ in FIG. 4 of the present invention. As shown in FIG. 4 and FIG. 5, when someone wants to assemble the speaker case 1 of the present invention, he or she can turn the main member 10 or the sound guiding member 20 180 degrees via at least one connecting portion 22 as a fulcrum to combine the main member 10 and the sound guiding member 20. Then the sealing portion 16 of the main member 10 can be correspondingly engaging with the corresponding sealing portion 26 of the sound guiding member 20. According to the above-mentioned structural design of the sealing portion 16 and the corresponding sealing portion 26, the cross-section of the sealing portion 16 is a trapezoid structure which corresponds to the trapezoid groove of the corresponding sealing portion 26. The two beveled sides of the trapezoid structure of the main member 10 can press tightly against the two beveled sides of the trapezoid groove of the corresponding sealing portion 26 to form a seal. Because the main member 10 and the sound guiding member 20 are made of a plastic material with elasticity, and the sealing portion 16 and the corresponding sealing portion 26 employ the design of the annular structures, which provide a better sealing and a buffer effect between the main member 10 and the sound guiding member 20. Therefore, the sound outputted by the speaker case 1 of the present invention can be focused through the sound guiding member 20, and the dispersion of the sound and structural vibration can be reduced.

Simultaneously, the main member 10 and the sound guiding member 20 combine firmly with each other via the at least one fixing portion 14 fastening to the at least one corresponding fixing portion 24. According to the above-mentioned structural design of the fixing portion 14 and the corresponding fixing portion 24, the hook of the corresponding fixing portion 24 can be inserted into the aperture of the fixing portion 14 and hook onto the main member 10 to combine the main member 10 and the sound guiding member 20.

Accordingly, the speaker case 1 of the present invention can be assembled easily without any tools, and provides good sealing and buffer effects via the sealing portion 16 engaging the corresponding sealing portion 26. Furthermore, the speaker case 1 of the present invention reduces costs of manufacture and assembly via the integrated structure of the main member 10 and the sound guiding member 20.

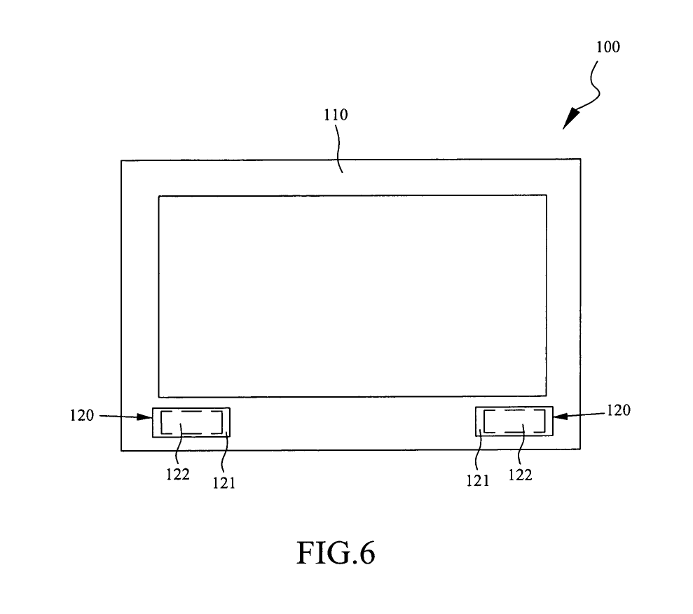

Please refer to FIG. 6. FIG. 6 is an illustrative view showing an electronic apparatus 100 disposed at least one speaker module 120 of the present invention. As shown in FIG. 6, the electronic apparatus 100 comprises a main body 110 and the at least one speaker module 120. Each speaker module 120 comprises the above-mentioned speaker case 121 and a speaker 122 disposed in the speaker case 121. The electronic apparatus 100 can provide the audio playing function via the at least one speaker module 120. In this embodiment, the electronic apparatus 100 of the present invention is a television, e.g. an LCD-TV, a PDP-TV, or other electronic apparatus with an audio playing function or the like; however, the present invention is not limited thereto. Accordingly, the outputted sound may be focused by the speaker module 120 of the electronic apparatus 100 of the present invention to provide a good audio effect for users.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A speaker case comprising:
a main member comprising at least one fixing portion and a sealing portion; and
a sound guiding member comprising at least one connecting portion, at least one corresponding fixing portion, and a corresponding sealing portion, the sound guiding member being connected to the main member via the at least one connecting portion, wherein each corresponding fixing portion corresponds to each fixing portion, and the corresponding sealing portion corresponds to the sealing portion;
the at least one connecting portion is capable of being a fulcrum for turning the main member or the sound guiding member, and the main member can be combined with the sound guiding member by fastening each fixing portion and each corresponding fixing portion together.

2. The speaker case as claimed in claim 1, wherein when the main member and the sound guiding member are combined, a sealing status between the main member and the sound guiding member is formed by engaging the sealing portion with the corresponding sealing portion.

3. The speaker case as claimed in claim 2, wherein the sealing portion is an annular protrusion structure, and the corresponding sealing portion is an annular groove structure; the sealing status between the main member and the sound guiding member is formed by engaging the annular protrusion structure with the annular groove structure.

4. The speaker case as claimed in claim 1, wherein the main member and the sound guiding member form an integrated structure.

5. The speaker case as claimed in claim 1, wherein the main member and the sound guiding member are made of a plastic material.

6. The speaker case as claimed in claim 1, wherein each fixing portion is an aperture, and each corresponding fixing portion is a hook.

7. The speaker case as claimed in claim 1, wherein the main member further comprises at least one fixing structure for combining the speaker case with an electronic apparatus.

8. An electronic apparatus comprising:
a main body; and
at least one speaker module disposed in the main body, each speaker module comprising:
a speaker case comprising:
a main member comprising at least one fixing portion and a sealing portion;
a sound guiding member comprising at least one connecting portion, at least one corresponding fixing portion, and a corresponding sealing portion, the sound guiding member being connected to the main member via the at least one connecting portion, wherein each corresponding fixing portion corresponds to each fixing portion, and the corresponding sealing portion corresponds to the sealing portion; and
a speaker disposed in the speaker case;
the at least one connecting portion is capable of being a fulcrum for turning the main member or the sound guiding member, and the main member can be combined with the sound guiding member by fastening each fixing portion and each corresponding fixing portion together.

9. The electronic apparatus as claimed in claim 8, wherein when the main member and the sound guiding member are combined, a sealing status between the main member and the sound guiding member is formed by engaging the sealing portion with the corresponding sealing portion.

10. The electronic apparatus as claimed in claim 9, wherein the sealing portion is an annular protrusion structure, and the corresponding sealing portion is an annular groove structure; the sealing status between the main member and the sound guiding member is formed by engaging the annular protrusion structure with the annular groove structure.

11. The electronic apparatus as claimed in claim 8, wherein the main member and the sound guiding member form an integrated structure.

12. The electronic apparatus as claimed in claim 8, wherein the main member and the sound guiding member are made of a plastic material.

13. The electronic apparatus as claimed in claim 8, wherein each fixing portion is an aperture, and each corresponding fixing portion is a hook.

14. The electronic apparatus as claimed in claim 8, wherein the main member further comprises at least one fixing structure for combining the speaker case with the main body.
